(19) United States
(12) Patent Application Publication
(10) Pub. No.: US 2025/0160354 A1
(43) Pub. Date: May 22, 2025

(54) Method and Apparatus for Processing Breast Milk

(71) Applicant: Mother’s Milk Is Best, Inc., Fort Collins, CO (US)

(72) Inventors: Elizabeth Rinaldi Schinkel, Fort Collins, CO (US); Elizabeth Nelson, Wellesley, MA (US)

(73) Assignee: Mother’s Milk Is Best, Inc., Fort Collins, CO (US)

(21) Appl. No.: 19/031,704

(22) Filed: Jan. 18, 2025

Related U.S. Application Data
(63) Continuation-in-part of application No. 17/536,274, filed on Nov. 29, 2021.
Application No. 17/536,274 is a division of application No. 14/589,945, filed on Jan. 5, 2015, now abandoned.
(60) Provisional application No. 62/050,898, filed on Sep. 16, 2014.
(60) Provisional application No. 61/923,542, filed on Jan. 3, 2014.
(60) Provisional application No. 63/640,862, filed on Apr. 30, 2024.

(51) Int. Cl. A23C 9/20; A23C 9/14; B01D 61/00

(52) U.S. Cl. CPC A23C 9/206; A23C 9/14; A23C 2210/20; B01D 61/002

(57) ABSTRACT

Methods, devices, and systems for concentrating breast milk are described. Concentrating nutrients in breast milk may be achieved using an apparatus comprising at least one forward osmotic membrane. In an example the apparatus can include a first sheet of material comprising a forward osmotic membrane, a second sheet of material sealed to the first sheet of material about a common outer perimeter thereof, the first sheet of material arranged so that water can traverse the forward osmotic membrane to an interior of the first and second sheets, and a dry carbohydrate within the interior of the first and second sheets exhibiting an osmotic draw property to draw water from un-concentrated, expressed human milk to form concentrated human milk. After a predetermined time, or upon the milk remaining after drawing of water through the membrane being a desired amount, the water draw can end.

### CROSS-REFERENCE TO RELATED APPLICATIONS

This application claims the benefit of U.S. Provisional Patent Application 63/640,862, filed on Apr. 30, 2024. This application is a continuation-in-part of U.S. patent application Ser. No. 17/536,274, filed on Nov. 29, 2021; which is a division of U.S. patent application Ser. No. 14/589,945, filed on Jan. 5, 2015; which claims the benefit of U.S. Provisional Patent Application 62/050,898, filed on Sep. 16, 2014; and claims the benefit of U.S. Provisional Patent Application 61/923,542, filed on Jan. 3, 2014. The entire contents of each of the aforementioned are incorporated by reference herein.

### BACKGROUND

Premature babies often benefit from ingesting a more nutrient-rich sustenance than provided by expressed human breast milk. To increase provided nutrition, supplements can be used to add nutrients to expressed human breast milk. Available supplements often contain cow's milk protein and/or soy. One human milk concentrator available is made with pooled human milk that is sterilized, destroying some of the nutrients found in fresh expressed human milk. These supplements are often the first foreign substances introduced to a baby's gut. The risk of intolerance of traditionally concentrated feedings is most notable for the potential development of necrotizing enterocolitis, which can lead to intestinal damage and even death.

There is a need for new and improved methods, devices, and systems for providing improved nutrition for premature infants.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, wherein like reference numerals designate corresponding parts throughout the views.

FIG. 1A is a side view showing a sequence of operations using one example of an apparatus incorporating the teachings herein.

FIG. 1B is a close-up view showing the apparatus of FIG. 1A with measurement indicia.

FIG. 2 is a flowchart of a process of manufacturing a pouch according to the teachings herein.

FIG. 3 is a cross-section of one example pouch according to the teachings herein.

FIG. 4 is a flowchart of a process of using a pouch according to FIG. 3.

FIG. 5 shows an example method.

### DETAILED DESCRIPTION

Described are methods, devices, and systems for concentrating nutrients within breast milk. The teachings herein provide methods and devices for the concentration of human milk, including donor milk or a mother's own milk, for a premature or sick baby to the prescribed nutrient density optimal for growth and development. Some example devices are suitable for bedside use, and the addition of foreign nutrients and heat processing may be avoided. The concentration of immunoglobulins, such as IgA, and other unique nutrients that are provided in a mother's milk can be achieved without external pressure and by forward osmosis to protect fragile nutrients in the breast milk that can be damaged even by shaking the liquid too forcefully. The use of a forward osmotic membrane without nitrates allows for conservation of the immunoglobulin on the nutrient concentration side of the membrane and only water passes via forward osmosis to the other side of the membrane. The process can be performed efficiently to mitigate or prevent damage to time-sensitive components of breast milk. The process facilitates efficient nutrient concentration.

According to the teachings herein, a method can include placing, into contact with a quantity of un-concentrated, expressed human milk, a forward osmotic membrane separating a material exhibiting an osmotic draw property from the quantity of un-concentrated, expressed human milk to draw water from the quantity of un-concentrated, expressed human milk, to form concentrated human milk, and withdrawing the forward osmotic membrane from contact with the concentrated human milk when the concentrated human milk reaches a desired nutrient level.

An apparatus can include a first sheet of material comprising a forward osmotic membrane, a second sheet of material sealed to the first sheet of material about a common outer perimeter thereof, the first sheet of material arranged so that water can traverse the forward osmotic membrane to an interior of the first and second sheets, and a dry carbohydrate within the interior of the first and second sheets exhibiting an osmotic draw property to draw water from un-concentrated, expressed human milk to form concentrated human milk.

Premature babies can benefit from ingesting a more nutrient-rich sustenance than provided by un-concentrated, expressed human breast milk. Mother's own milk (MOM) has unique nutritional and health benefits for preterm infants and has been shown to reduce neonatal morbidity, mortality, and costs for a neonatal intensive care unit (NICU). Feeding preterm infants MOM improves brain, vision, microbiome and immune system development and reduces the incidence of bronchopulmonary dysplasia (BPD), retinopathy of prematurity (ROP), necrotizing enterocolitis (NEC), and neonatal sepsis. MOM is a complex, biologically active form of nutrition; its composition fluctuates due to maternal hormonal and dietary influences. Consequently, increasing MOM intake by preterm infants is highly desirable. However, even when abundantly available, MOM is generally not a sole nutrient source for preterm infants due to their high nutrient needs and low volume tolerances.

Most NICUs in the United States fortify MOM and donor human milk (DHM) with bovine milk-derived fortifiers, which are currently one of the only readily available, low-cost options to achieve adequate extrauterine growth. However, the use of bovine milk-derived fortifiers in preterm infant feeding may detrimentally impact human milk components and increase the risk of morbidities. Donor human milk (DHM)-derived fortifiers are also available, but are more limited in use due to higher cost, concerns about ethical sourcing, and a lack of proven efficacy. DHM-derived fortifiers may displace as much as 50% of MOM to achieve a caloric density adequate for preterm infant growth. Thus, there is a need for new and improved methods, devices, and systems for concentrating breast milk.

Passive osmotic concentration can be used as a point-of-care approach to increasing the nutrient and bioactive content of MOM. This approach avoids heat and pressure damage, avoids the risk of reaction to non-human proteins, and can prevent displacement of MOM. This process can use osmotic draw across a limited permeable membrane to remove only the smallest molecules (<0.0007 micron), such as water, from human milk (HM). The process can use one or more forward osmosis membranes, enclosing a draw material, to draw water through the membrane, without heat or pressure. The process is gentle and does not damage fragile components of breast milk, such as, bioactive molecules like human milk oligosaccharides, antioxidants, nucleotides, living cells such as stem cells and mammary epithelial cells, live probiotics, anti-pathogenic agents such as bile salt-stimulated lipase, and glycoproteins, macronutrients such as lactose, lipids, proteins such as lactoferrin, alpha-lactalbumin, immunoglobulins (IgA, IgG, IgM), enzymes (such as lipase, amylase), lipids (triglycerides, phospholipids, cholesterol, long-chain polyunsaturated fatty acids, docosahexaenoic acid, arachidonic acid), micronutrients such as-vitamins (fat-soluble-vitamins A,D,E, and K, water soluble (B-complex and Vitamin C), minerals (calcium, phosphorus, magnesium, iron, zinc, copper, sodium, potassium, chloride), immune components such as cytokines, secretory IgA, white blood cells, lactoferrin, lysozymes, human beta-defensin-1, growth factors including epidermal growth factor (EGF), insulin-like growth factors (IGF), transforming growth factor-beta (TGF-B), and hormones including leptin, adiponectin, cortisol.

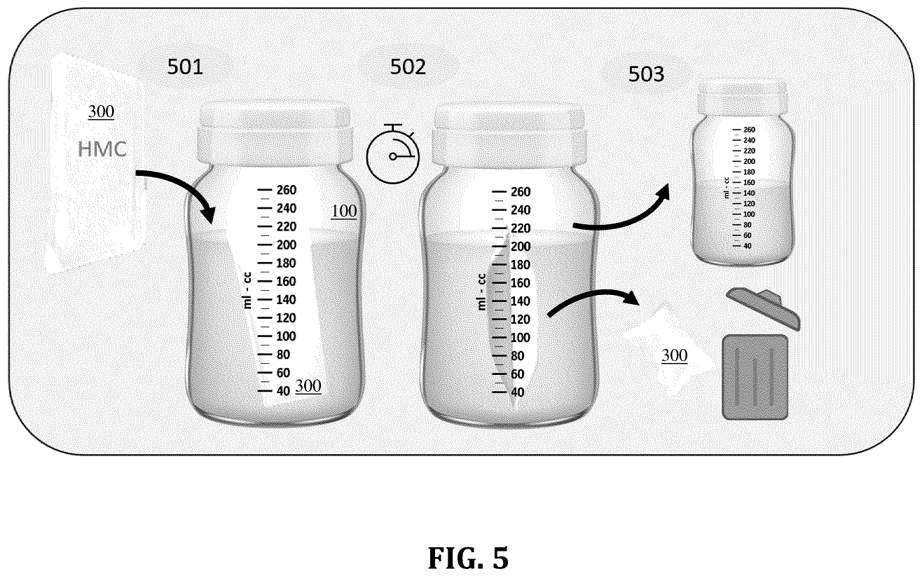

In an example method, as shown in FIG. 5, a single-use human milk concentration (HMC) device is composed of an osmotic membrane packet or pouch 300, that is added to fresh or thawed HM, in a container 100, and provides to passive concentration of HM components outside the pouch 300 by removal of water. In some examples, the device can remove a defined amount of water. This example device provides broad accessibility and facilitates implementation, because the HMC device was developed with attention to standard NICU feeding workflows, cost limitations, and is compatible with standard 50 mL to 240 mL breast pump bottles. The HMC device may be used while HM is stored under refrigeration or being warmed for feeding. This HMC device has been shown to increase the concentrations of macronutrients and bioactive molecules, such as immunoglobulins, in samples of previously frozen, pasteurized, and unpasteurized HM.

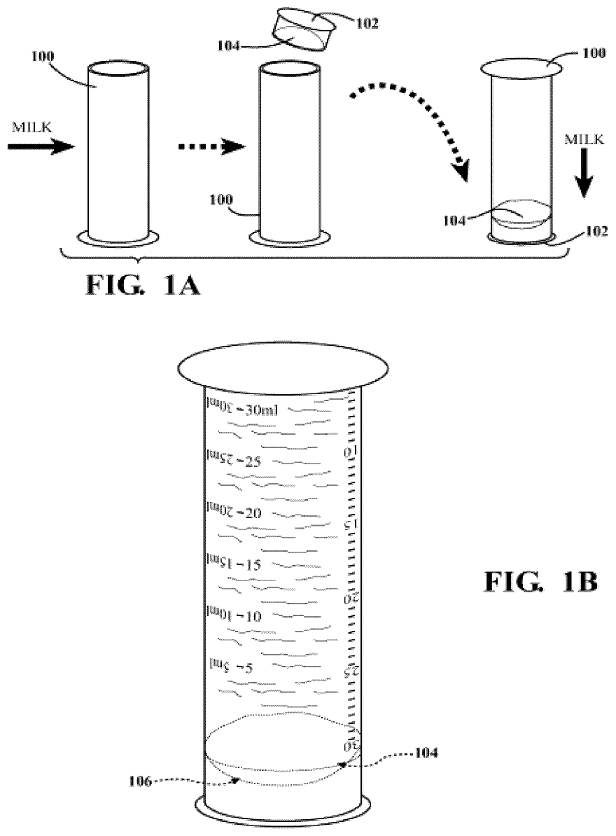

Another example apparatus is illustrated in FIGS. 1A and 1B. In the illustrated example the apparatus includes a container 100, which may be a bottle used for holding expressed breast milk, or another container that can hold a liquid. The container 100 may be a hand-held container. The bottle is filled with un-concentrated expressed breast milk. The illustrated container 100 includes a receptacle 102. In the system shown in FIGS. 1A and 1B, the receptacle 102 can seat or secure a forward osmotic membrane 104. In one example, the forward osmotic membrane 104 can be provided across a ring below threads for attaching a screw-on, cap-like receptacle 102 to the container 100.

The receptacle 102 can be a lid, a cap, an attachment, or other receptacle that can be releasably secured to the container 100. The container 100 and the receptacle can vary in size and shape to allow use of different sizes as needed to concentrate different amounts of human milk. Other shapes and materials may be used for the container 100, and techniques may be used to attach the container 100 and the receptacle 102 to form a seal that prevents fluid leaks from inside of the container 100 to outside of the container 100. A sealing ring or other type of sealing component made of an elastomeric polymer can be used, for example, to form a fluid-tight seal between the container 100 and the receptacle 102. It is beneficial for the container 100 and receptacle 102 to both be food-safe fluid containers. A pouch 106 can have at least one forward osmotic membrane defining an outer surface of the pouch. The pouch 106 can be contained within the receptacle 102 and is configured to be removably attached to the container 100. In some embodiments, the pouch 106 is affixed to the receptacle 102. In some embodiments, the pouch is removably seated into the receptacle 102. In some embodiments, the receptacle 102 is space-limited to prevent over-concentration.

In some examples, a container 100 holding the expressed breast milk has a volume in a range of 10 mL to 500 mL, in a range of 25 mL to 350 mL, in a range of 40 mL to 300 mL, in a range of 50 mL to 300 mL, in a range of 50 mL to 200 mL, or in a range of 50 mL to 250 mL for NICU point of care use or home use. For milk banks or pooled milk for home use, larger volumes can be used from 500 mL to 20 L, in a range of 500 mL to 1 L, in a range of 1 mL to 5 L, in a range of 5 L to 10 L, in a range of 10 L to 20 L, or in a range of 10 L to 15 L.

In an example, forward osmotic membrane 104 may form a pouch 106, 300 within receptacle 102 that is filled with a draw material such as a dry carbohydrate or mix of dry carbohydrates that will draw water from the milk and hold that water within the contours of pouch 106, 300 and forward osmotic membrane 104. In one implementation, forward osmotic membrane 104 uses sucrose as the draw material. A filler material may be used to support the draw material. The filler material can be inert to the expressed breast milk and designated as safe for contact with food. In one example implementation, the pouch 106, 300 is expandable as water is pulled across forward osmotic membrane 104 and into the draw material; and forward osmotic membrane 104 forms pouch 106, 300 with a second sheet of expandable material sealed with forward osmotic membrane 104. In another example implementation, the pouch 106, 300 is not expandable. That is, the forward osmotic membrane 104 forms the pouch with a second sheet of non-expandable material sealed with forward osmotic membrane 104 such that the pouch 106, 300 is sized for an amount of water it is expected to hold.

Referring to FIGS. 1A and 1B, in this system, once the receptacle 102 is attached to the container 100, the container 100 can be turned upside down such that the milk contacts one side of the forward osmotic membrane 104. The draw material supported within the pouch 106 will draw water with no external pressurization. In this embodiment, the receptacle 102 can be space limited to prevent over-concentration of the human milk.

The system removes water to concentrate the expressed breast milk into concentrated breast milk, whereby a total quantity of immunoglobulins is substantially the same in the concentrated breast milk as compared with the expressed breast milk. In some examples, the system removes water to concentrate the expressed breast milk into concentrated breast milk, whereby the concentrated breast milk has about 1.1 to 2.0 times the Kcal per ounce as compared with the expressed breast milk.

In some examples, the system removes water to concentrate the expressed breast milk into concentrated breast milk, whereby the concentrated breast milk has between 1.1 to 1.9 times, between 1.2 to 1.8 times, between 1.2 to 1.6 times, between 1.3 to 1.9 times, or between 1.2 to 1.5 times the Kcal per ounce as compared with the expressed breast milk. In some examples, the system is configured to remove between 5% to 50% of water from the expressed breast milk. In some examples, the system is configured to remove between 5% to 30% of water, between 10% to 45% of water, between 15% to 40% of water, between 10% to 30% of water, or between 20% to 30% of water. In certain embodiments, the system is configured to remove about 25% of the water.

In one example, the pouch 106, 300 can be used to concentrate expressed human milk from about 20 kilocalories (kcal) per ounce to about 24 kcal per ounce. The container 100 may be filed with up to 30 milliliters (ml) of human milk. Once the human milk has been disposed within the container 100 and the receptacle 102 is attached to the container 100, the bottle can be inverted to begin the process of concentrating the human milk. The forward osmotic membrane 104 of the pouch 106 expands to fill the receptacle 102. Once a desired amount of water is drawn into the pouch 106 that is sufficient to fill the receptacle 102, the remaining breast milk can have the desired concentration level of nutrients. In another embodiment, the filtering of the human milk can be timed. The bottle can then be inverted such that the receptacle 102 can be removed from the container 100 and discarded as waste or repurposed for another use. The pouch 106 can be discarded such that the receptacle 102 is reusable with a new pouch that is similar to the pouch 106. A nipple, or other suitable device for delivering the concentrated milk to an infant can be attached to the container 100 to feed the infant. Alternately, the concentrated milk can be transferred to another delivery device for ingestion by the infant or other individual needing the nourishment.

In another embodiment, the forward osmotic membrane 104 is fitted across and secured to the receptacle 102 by a technique to seal draw material within the receptacle 102. In this example, the forward osmotic membrane 104 can omit an opposing second sheet for forming the pouch 106. The filing can occur until the level of liquid within the receptacle 102 that is drawn into the draw material reaches a level expected to produce a desired concentration of nutrients in the human milk remaining within the container 100 or until a desired time lapses.

The process of concentrating expressed human milk may be used with a single use, disposable pouch 106, 300 comprising the forward osmotic membrane. In some alternate examples, the process of concentrating expressed human milk may be used with one or more reusable forward osmotic membranes. Reusable devices may be suited for reuse if the use is by a single user, if the receptacle is configured for replacement of the draw material, and if cleaning is feasible.

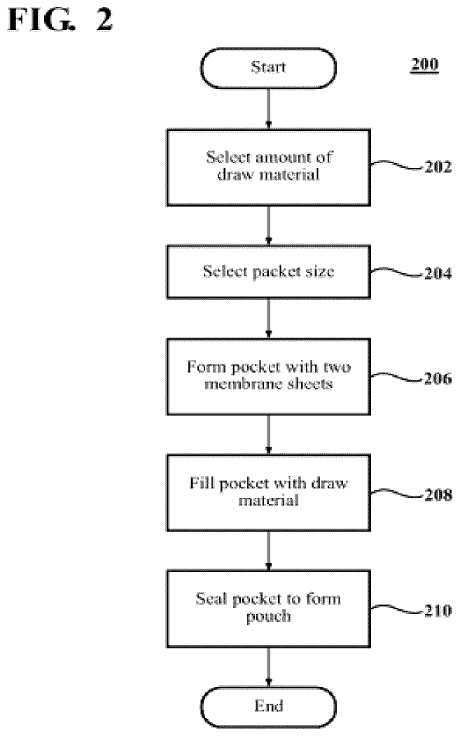

In another embodiment, regardless of whether the pouch is formed of an expanding material or non-expanding material with the forward osmotic membrane, the forward osmotic membrane 104 may be formed in the shape of a teabag and dropped into a container of unconcentrated, expressed milk. That is, the forward osmotic membrane 104 is not attached for use with the receptacle 102. It could be, for example but not limited to, in the shape of a teabag. Once the forward osmotic membrane 104 has removed the desired amount of water, the forward osmotic membrane 104 can be removed from the concentrated breast milk. This example is described in more detail with respect to FIGS. 2-4.

In another example, the pouch 106, 300 may be used with the apparatus of FIG. 1, the method of FIG. 5, or as described with respect to a process 200 of FIG. 2. FIG. 2 illustrates a method of creating a pouch 300. The method involves selecting an amount of draw material 208. The amount of draw material 312 is selected based on the amount of water to be drawn from the expressed milk. The amount may be selected based in part on the size of the forward osmotic membrane. For example, the same amount of draw material 312 would draw water faster when used with a forward osmotic membrane having a larger surface area than one having a smaller surface area. As mentioned, the draw material used for drawing the water across the forward osmotic membrane may be a dry carbohydrate. In an example, the draw material can include one or more of: sucrose, dextrose, or lactose. Mixtures of various dry carbohydrates can also be used. The form of the dry carbohydrate can include, but is not limited to, a fine powder or pellets. The one or more dry carbohydrates may be mixed with a filler material as described above to, for example, increase the shelf life of the concentrated breast milk. In another embodiment, the dry carbohydrate is a food-grade, superfine powder.

A draw material 312 can be contained within an interior of the pouch 106, 300. In one example, a pouch encloses, contains, or comprises: approximately 2 g of draw material by dry weight. In some examples, the pouch contains between 1 g to 250 g draw material, 5 g to 100 g draw material, 15 g to 100 g draw material, 15 g to 80 g draw material, 10 g to 60 g draw material, 15 g to 50 g draw material, 10 g to 30 g draw material, or 1 g to 20 g draw material or lower. In an example, an interior of the pouch 106, 300 can further include a gelling agent, and water drawn into the pouch may be bound by the gelling agent. In some examples, the pouch encloses, contains, or comprises: between 1.0 g to 25 g of the gelling agent by dry weight. For larger packet sizes for use in milk banks or pooled milk for home use, the pouch contains between 10 g to 1500 g draw material, 100 g to 1500 g draw material, 150 g to 1000 g draw material, 150 g to 800 g draw material, 100 g to 600 g draw material, 150 g to 500 g draw material, 100 g to 300 g draw material, or 200 g to 400 g draw material.

The method can include selecting a packet size 204. The size can be selected in conjunction with the selection of the amount of draw material that is selected and may be dictated by the application, such as the size of the container in which the breast milk will be processed. Such as the container 100 illustrated in FIG. 1.

In some examples, a pouch 106, 300 can have a surface area greater than 20 cm², 30 cm², 40 cm², 50 cm² 60 cm², 70 cm², 80 cm², 90 cm², 100 cm², 150 cm², or 200 cm². In some examples, a pouch 106, 300 can have a surface area less than 1000 cm², 800 cm², 600 cm², 500 cm² 450 cm², 400 cm², 300 cm², 250 cm², 200 cm², 180 cm², 150 cm², or 100 cm². In some examples, a pouch 106, 300 can have a surface area in a range of: 20 cm² to 400 cm², or can have a surface area of about 35 cm² to 175 cm². The pouch can also be sized for pooled breast milk contained in 1-15 L batches in human milk banks. In some examples, a pouch 106, 300 can have a surface area greater than 200 cm², 300 cm², 400 cm², 500 cm² 600 cm², 700 cm², 800 cm², 900 cm², 1000 cm², 1500 cm², or 2000 cm². In some examples, a pouch 106, 300 can have a surface area less than 10000 cm², 8000 cm², 6000 cm², 5000 cm² 4500 cm², 4000 cm², 3000 cm², 2500 cm², 2000 cm², 1800 cm², 1500 cm², or 1000 cm². The pouch would fit in a 15 L container including a cylindrical container of diameter 25 cm by 31 cm, rectangular container of 25 cm×20 cm×30 cm or square based container 20 cm×20 cm×37.5 or smaller container. The pouch would fit in a 1 L container including a cylindrical container of diameter 10 cm by 13 cm, rectangular container of 10 cm×5 cm×50 cm or square based container 10 cm×10 cm×10 cm.

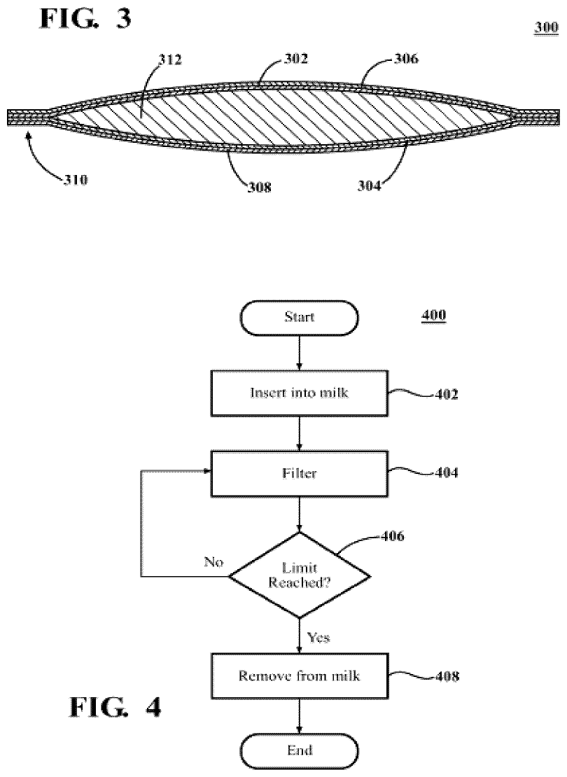

The method can include forming a pocket from two membrane sheets 206. In one of the embodiments described above, a pouch 106, 300 is formed of a single forward osmotic membrane 104. However, a pouch 300, illustrated in FIG. 3, can be formed with two forward osmotic membrane sheets including a first sheet 302 and a second sheet 304. A first sheet is joined to a second sheet such that the first sheet 302, and the second sheet 304 are arranged back-to-back such that the osmotic draw is to the interior of both the first sheet 302 and the second sheet 304. The first sheet 302 and the second sheet 304 can be sealed about most of the edge surface using a press or other techniques, including, for example by the application of heat. One example of sealing about most of the edge surface when membrane sheets 302, 304 are rectangular involves sealing about three of the four edges. Optionally, membrane sheets 302, 304 may be sealed with similarly-sized sheets 306, 308 of a laminate film to form a seal 310 about a portion of the outer perimeter.

The first sheet 302 and the second sheet 304 may be formed of a plurality of materials such as a polyethylene or polyester substrate with cellulose and a drying agent, such as glycerine. Preferably, at least the outside-facing surfaces of the first sheet 302 and the second sheet 304 are approved for contact with food. The glycerine can serve to seal micropores in the substrate to protect the micropores from being sealed by the draw material 312. Other materials that can help maintain pore structure include polymeric additives, sugars, polyols, proteins, amino acids, and salts.

In an example, forward osmotic membranes can be procured from Hydration Technology Innovations, LLC of Albany, OR, within the OsMem FO family of membrane products. In some examples, the laminate film is optional and may be used for protection in shipping or for structural support. Where a laminate film is used, it may be formed of a number of materials both safe for use with food products and permeable to liquid. Alternatively, the laminate film may be impermeable to liquid and removed prior use of the pouch 300. In another embodiment, the first similarly-sized sheet 306 and the second similarly-sized sheet 308 can be a laminate comprising, for example, one or more of the following-a high-density polyethylene (HDPE), hydrogel, polycarbonate, polyethylene terephthalate, polypropylene, polyurethane, low-density polyethylene (LDPE) linear low-density polyethylene, or medium-density polyethylene (MDPE) resin, hydrogel, polycarbonate, polyethylene terephthalate, polypropylene, polyurethane, polyvinyl chloride, polystyrene or ethylene polymers approved for use in the manufacture of articles intended for contact with food.

In some examples, the pouch comprises at least one forward osmotic membrane, at least one laminate film, and a draw material. In some examples, the pouch comprises at least one of: a drying agent-organic, inorganic or polymer additives, or cellulose, glycerine, polyethylene glycol, calcium chloride, silica gel, magnesium sulfate, polyvinylpyrrolidone, cellulous derivative, activated alumina, phosphorus pentoxide, a polyester substrate, polyethylene substrate, high-density polyethylene (HDPE), low-density polyethylene (LDPE), medium-density polyethylene (MDPE), resin, polylactic acid (PLA), ethylene polymer, or a thermoplastic resin. Draw solutions could include dextrose, glucose, magnesium chloride, calcium chloride, potassium chloride, sucrose, hydrogel, poly (N-isopropylacrylamide), magnetic nanoparticles, sodium polyacrylate, polystyrene sulfonate, functionalized silica nanoparticles, three dimensional hydrophilic polymers, alginate, chitosan, hyaluronic acid, polyacrylamide (PAM), polyvinyl alcohol (PVA), polyethylene glycol, poly (N-isopropylacrylamide) (PNIPAM).

A method 200 for making the device can include a step 206 of forming a pocket from two membrane sheets, and a step 208 of filling the pocket with draw material. The membrane sheets can comprise at least one of the following biodgradable plant-based fibers, nylon, polyester, polylactic acid (PLA), three dimensional hydrophilic polymers, alginate, chitosan, hyaluronic acid, polyacrylamide (PAM), polyvinyl alcohol (PVA), polyethylene glycol, poly (N-isopropylacrylamide) (PNIPAM), polyester, polypropylene, polyethylene, nonwoven fabrics, polyaramid fibers, thin-film polyamide, polysulfone, polyethersulfone, The method can include a step 210 of sealing the pocket to form a pouch. Although FIG. 2 illustrates that the draw material 312 is filled into the pocket after forming a pocket with the first sheet 302 and the second sheet 304, the draw material 312 can be placed in the center of the first sheet 302 and the second sheet 304 and then sealed to form a pouch. Optionally, the pouch 300 can be sealed within a thermoplastic resin for transportation and storage. In one example method 200, the pouch 300 is formed of two sheets of forward osmotic membrane 104. In other example methods, the pouch 300 may be formed of a single forward osmotic membrane 104 folded over itself so as to form the pocket for draw material 312. In another example, a pouch 300 can comprise a single sheet of a forward osmotic membrane 104 forming a pouch with a second sheet comprising another material.

Referring now to FIG. 4, a method 400 of using the pouch 300 is described. The method can include inserting the pouch 300 into the un-concentrated, expressed breast milk 402. The method can include filtering water from the breast milk with the pouch 300 by a step 404 of drawing the water through the first sheet 302 and/or the second sheet 304 into the draw material 312. The method can include a step 408 of ending the concentration process upon reaching a desired endpoint or limit 406. The endpoint can be determined by a time period or by a volume of fluid in the container. If the limit has not been reached, the concentration of the breast milk 404 can be repeated until the limit has been reached. The method can include removing the pouch from the concentrated breast milk.

Referring again to FIG. 5, an example method is shown. At step 501 a volume of unconcentrated expressed breast milk is provided in a container 100, and a human milk concentration (HMC) device is prepared and provided in the form of a pouch 300. The milk is human milk (HM), and may be a mother's own milk (MOM) or donor human milk (DHM). The expressed breast milk may be fresh, stored, or thawed. The pouch may be single-use, disposable pouch. In some examples, preparing the pouch can include wetting the pouch, for example by placing it in warm sterile water for 5-60 seconds, then removing it form the warm water, and excess water may be shaken off. The pouch 300, is placed into the container 100 and contacts the expressed breast milk.

As shown in step 502, the pouch 300 contacts the expressed breast milk for contact time. The milk may be warmed during the contact time. The milk may be kept at a refrigerated storage temperature during the contact time. The expressed breast milk is liquid, or at least mostly liquid, during the contact time.

In some examples, a contact time, from a time of placing the forward osmotic membrane into contact with the expressed breast milk in the container, to a time of removing the forward osmotic membrane from contact with the concentrated breast milk, is a predetermined time. The period of time can be a preset period, such as between 10 minutes and 24 hours. The period of time can be a preset period determined by preparation conditions. As an example, a contact time, while warming the milk from a first temperature in a range of 4° C.-25° C. to a feeding temperature in a range of 30° C.-38° C., may be about 25 minutes, or in a range between 10 to 120 minutes. As another example, a contact time, while storing the milk in a refrigerator or cooler at a temperature of about 4° C., or in a range of 3° C.-12° C., the preset contact period may be about 3 hours, or in a range of 1 hour to 24 hours.

In another example, a contact time can be determined by a reduction in volume. For example, an initial volume can be recorded for the expressed breast milk, and the initial volume may be compared with a concentrated volume. For example, the pouch may be lifted out of the milk in the container to view the concentrated volume. In some examples, the contact period is selected to end when the volume in the container, excluding the volume in the pouch, has decreased from the initial volume by about 25%, or by between 10% to 50%, by between 15% to 40%, by between 15% to 30%, by between 20% to 35%, or by between 20% to 30%.

As shown in step 503, the pouch 300 is removed from the container 100 at the end of the contact time. The container holds a volume of concentrated breast milk which may be used for feeding immediately or stored for later feeding. The example pouch 300 shown in FIG. 5 is a disposable, single use pouch which can be discarded after being removed from the container.

### EXAMPLES

Example 1: In a study to test the timing of the water draw, a 3 in×3 in forward osmosis pouch formed with two sheets of a forward osmotic membrane and filled with 10 g of sucrose as described with respect to FIGS. 2 and 3 was placed into 90 mL of whole cow's milk. The milk was stored in a sealed container for two hours at room temperature, after which the pouch was removed. The remaining milk was measured and demonstrated that 12 mL of water was removed from the milk.

In another study, a 3 in×3 in forward osmosis pouch was formed with two sheets and filled with 10 g of sucrose as described with respect to FIGS. 2 and 3 was placed in 60 mL of whole cow's milk. After two hours at room temperature in a sealed container, the pouch was removed. The remaining milk was measured and demonstrated that water in the amount of 14 mL was removed.

In another study, human milk sample studies were performed. In one test, two 3.5 in×3.5 in forward osmosis pouches were used. Each was formed with two sheets of the same forward osmotic membrane used in the cow's milk studies, and each was filled with 20 g of sucrose. The pouches were rinsed in hot water for 15 minutes before use to remove the glycerine, although this step is optional. Each pouch initially weighed 22 grams, which weight was increased by 10 g at the end of the rinse. The increase weight per pouch was due the draw of water across the forward osmotic membranes and into the pouch during the rinse. The two pouches were added to 235 mL of expressed human milk. The pouches were soaked for 3.25 hours in the milk stored in a refrigerator at 34 degrees Fahrenheit in a covered container. After the soak, the two pouches were removed and weighed. The milk remaining in the sample demonstrated low water removal—the amount of water removed was insufficient to achieve the desired nutrient levels in the concentrated milk. Due to this low water removal, a third 3.5 in.×3.5 in. forward osmosis pouch, also formed with two sheets of the same forward osmotic membrane and filled with 20 g of sucrose as described with respect to FIGS. 2 and 3, was subjected to the optional hot water rinse for 15 min. The third pouch experienced the same weight increase as the first two. After rinsing, the pouch was placed within the remaining milk (that is, the now partially-concentrated human milk). The milk, with the pouch, was placed in the refrigerator and soaked for 2.0 hours at 34 degrees Fahrenheit in a covered container. The third pouch was removed at the end of the soak after removing the milk from the refrigerator. The total water removed by all three pouches was 29 mL. The fluid lost in processing was 10 ml. After processing, concentrated (processed) milk in the amount of 196 mL was analyzed for nutrient and glycerine content. A 120 ml control sample of un-concentrated (unprocessed), expressed human milk to which no filtering was applied was analyzed for nutrient content. Results of the comparison of studies are as produced below in Table 1.

| | | | |
|---|---|---|---|
| Ash | 0.18 | 0.23 | g/100 g |
| Total Calories (calculated) | 57 | 66 (for 98 ml) | kcal |
| Chloride | 50 | 50 | mg/100 g |
| Dietary Fiber | <0.5 | <0.5 | mg/100 g |
| Moisture (Air Oven) | 88.84 | 86.55 | g/100 g |
| Protein | 1.06 | 1.29 | g/100 g |
| Saturated Fat | 0.82 | 0.86 | g/100 g |
| Sugars | 5.5 | 7.0 | g/100 g |
| Vitamin A | 590 | 540 | I.U./100 |
| Calcium | 2.9 | 3.9 | mg/100 g |
| Carbohydrates (calculated) | 7 | 9 | g/100 g |
| Cholesterol | 9 | 10 | mg/100 g |
| Iron | <0.15 | <0.15 | mg/100 g |
| Phosphorus | 90 | 10 | mg/100 g |
| Modified Reese Gottlieb Ether | 2.55 | 2.62 | g/100 g |
| Extraction Method (Fat Standard | | | |
| measure) | | | |
| Sodium | 26 | 29 | mg/100 g |
| Trans Fat | 0.02 | 0.02 | g/100 g |
| Vitamin C | <0.1 | <0.1 | mg/100 g |

Ash, Chloride, Dietary Fiber, Moisture, Protein, Saturated Fat, Cholesterol, Phosphorus, Tans fat, and Vitamin C were all measured according to the applicable Official Methods of Analysis of AOAC INTERNATIONAL (OMA). Vitamin A, Iron, and Sodium were measured according to known testing (e.g., WRE) methods. Sugars were measured according to a method compliant with both OMA and WRE. Calcium was measured according to the Environmental Protection Agency (EPA) 6020 method.

As can be seen from the test results illustrated in Table 1, desirable increases in Calories (caloric content), Protein, Saturated Fat, Sugars, Calcium, Sodium, and Carbohydrates resulted, with little change in other content characteristics except for Phosphorus. It is believed that the reduction in Phosphorus is an error. Glycerin content was negligible, and this result is not expected to change even when the optional rinsing step does not occur.

From the studies, it is noted that the lower temperatures used during the soaking/filtering step for the breast milk samples as compared to that used for the cow's milk samples notably slowed the water draw from the samples. An increased amount of draw material and/or a higher temperature during the soaking/filtering step would promote faster milk concentration by forward osmosis.

As mentioned, the temperatures used in the testing described herein were room temperature (up to 77 degrees Fahrenheit or 25 degrees Celsius) and as low as 37 degrees Fahrenheit. Higher temperatures are possible to speed up the process, but this may result in a corresponding reduction in the storage life of the milk. For example, room temperature storage of breast milk is not recommended for more than 6-8 hours. (See Academy of Breastfeeding Medicine, “Clinical Protocol Number #8: Human Milk Storage Information for Home Use for Healthy Full Term Infants,” 2004 (Princeton, NJ)). Refrigerator temperatures are often up to 39 degrees Fahrenheit or 4 degrees Celsius, and storage of five days is possible. An insulated cooler bag can keep the milk fresh for 24 hours at temperatures of up to 39 degrees Fahrenheit. Milk stored for longer durations at the temperatures described is safe, but some of the lipids, even at an increase in the temperature of the milk from 37 degrees Fahrenheit to 39 degrees Fahrenheit is expected to increase the speed of the soaking/filtering step. If the soaking/filtering step is done at room temperature, immediate use can be desirable.
Example 2: Fresh human milk samples were collected within 30 mins to 20 hours (avg 11.5 h) after expression. Prior to collection, the samples were stored by the donors at 4 degrees Celsius. Before removing the aliquos for baseline analysis and passive osmotic concentration, the HM samples were each gently swirled to mix the contents. The aliquot removed for baseline analysis of unconcentrated human milk was stored at 4 degrees Celsius.

Passive osmotic concentration was performed as follows. First the pouch was rinsed with filtered water warmed to 38 degrees Celsius and placed in 75 m of fresh human milk in an 80 ml (polypropylene, non-BPA) volume-marked bottle. Next, the bottle was capped and stored at 4 degrees Celsius for 3 hours to allow passive osmotic concentration of the human milk. Finally, the pouch was removed, and the masses of the human milk and the pouch were determined. Analyses of the cell viability and energy, fat, carbohydrate, and protein contents of the concentrated milk were performed immediately. The remaining matched human milk samples (unconcentrated and concentrated) in their respective containers were each gently swirled to combine their contents, then aliquoted and shipped overnight on dry ice to individual laboratories for other analyses.

### Macronutrients

The concentrations of energy, fat, carbohydrates, protein (crude), and true protein in the human milk samples were analyzed using a Miris Human Milk Analyzer according to the published device protocol. The samples were heated to 40 degrees Celsius and homogenized. Each measurement required 2 mL of human milk, and the samples were analyzed in duplicate. The crude protein was determined by assuming that 20% of the crude protein measurement is attributable to non-protein nitrogen.

### Component Analysis

The samples were received frozen and were stored at −80 degrees Celsius until analysis, which was performed immediately after thawing. The average coefficient of variation (CV) for protein concentration was 4.0% with a range of from 0.7% to 9.3%. The average CV for lactoferrin concentration was 3.5% with a range of 0.7% to 11.4%. The average CV for active IgA concentration was 3.9% with a rang of 0.8% to 8.5%. The average CV for sodium concentration was 0.1% with a range of 0.0% to 0.6%.

### Enzymatic Activity Analysis

The samples were thawed at 4 degrees Celsius and centrifuged at 4250×g for 10 mins at 4 degrees Celsius. The infranatant from below the upper-fat layer was collected by pipette and stored in 400 μL aliquots at-80 degrees Celsius until use in assays. The aliquots were thawed only once to avoid possible enzyme degradation during thawing and freezing. The human milk samples were used at 1× and 2× dilutions for lysozyme activity assays, 4× and 8× dilutions for PAF acetyl hydrolase activity assays, 50× and 100× dilutions for catalase activity assays, and 400× and 800× dilutions for glutathione peroxidase activity assays. Human milk samples were used at 2× and 4× solutions for Bile salt-simulated lipase activity. A standard curve was constructed by serial dilution of p-nitrophenol to obtain a nitrophenol from p-nitrophenyl myristate was measured in a spectrophotometer by monitoring the absorbance at 405 nm every 30 s for 10 mins at 37 degrees Celsius.

### Oligosaccharide Analysis

Nineteen human milk oligosaccharides (HMOs) were selected for analysis. These HMOs were selected because their absolute concentrations can be measured via separation and identification on an HPLC column with chemically defined standards used as a reference. The HMOs analyzed were: 2′-fucosyllactose (2′-FL), lacto-N-difucohexaose I (DFLNT), lacto-N-hexaose (LNH), disialyllacto-N-tetraose (DSLNT), 3-fucosyllactose (3FL), lacto-N-neotetraose (LNnT), sialyl-lacto-N-tetraose c (LSTc), disialyllacto-N-hexaose (DSLNH), 3′-sialyllactose (3′-SL), fucosyllacto-N-hexaose (FLNH), difucosyllacto-N-hexaose (DFLNH), difucosyllactose (DFLAC), lacto-N-tetraose (LNT), 6′-salyllactose (6′SL), lacto-N-fucopentaose I (LNFP 1), lacto-N-fucopentaose ll (LNFP ll), lacto-N-Fucopentaose lll (LNFP lll).

### Small Molecule Analysis

The concentrations of free choline, phosphocholine, betaine, phosphatidylcholine (PC) and sphingomyelin (SPH) were determined by high-performance liquid chromatography tandem mass spectrometry (HPLC-MS/MS) using stable isotope-labeled internal standards. The quantitative HPLC-MS/MS assay was highly reproducible for free choline and betaine measurements, with inter- and intra-assay CVs of ˜3%. However, the quantitative HLC-MS/MS assay was not highly reproducible for phosphocholine measurement, with inter- and intra-assay CVs of <12%. PC and SPH were analyzed separately. The CVs were 4% for PC analysis and 10% for SPH analysis.

### Fatty Acid Analysis

Fatty acid content was analyzed by gas chromatography (GC). Hydrogen was used as the carrier gas. To determine fatty acid content, the area counts of individual fatty acids were compared to the area counts of known quantities of nonanoic acid (C9:0) and heptadecanoic acid (C17:0), which were added to the human milk samples as internal standards. The inclusion of internal standards also enabled the correction of the detector response for short-chain fatty acids of 12 carbons or fewer. The total fatty acid content was calculated by summing the contents of the individual fatty acids. For quality control of the total fatty acid and individual fatty acid content measurements, one milk sample was analyzed 5 times on the same day to determine the intra-assay variability, and the same sample was analyzed on 4 additional days to determine the inter-assay variability. The quantitative GC-FID assay for total acids was highly reproducible, with inter- and intra-assay CVs of <2%. The relationship between Human Milk sample volume (i.e., total fatty acid quantity) and total fatty acid content was linear between ˜3.75 and 6.1 g/dL (r²=0.996).

### pH and Osmolality Analysis

The pH and osmolality of human milk were analyzed using concentrated and unconcentrated Human Milk samples that had been shipped on dry ice and stored at-80 degrees Celsius. After thawing, the pH of the sample was measured with a SevenCompact S220 pH/ion meter equipped with a combined sealed glass electrode. The electrode was equilibrated before the pH value was recorded. Osmolality was measured in duplicate using an osmometer after calibrating the machine with a 290 mOsm, a third reading was taken. Only 1 sample required a third reading.

### Human Milk Cell Viability Analysis

Briefly, the human milk samples were diluted 1:2 with PBS and centrifuged at 800×g for 20 min. The fat layer and supernatant were removed, and the cell pellet was resuspended in 1-2 ml of PBS and centrifuged again. Ater another round of resuspension in PBS and centrifugation to wash the cells, the supernatant was removed, and the cells were resuspended in a small volume of PBS. Finally, the cells were counted using trypan blue exclusion in an automated cell counter. Samples were processed pairwise, and the percentages of the live and dead cells were compared between unconcentrated and concentrated human milk samples.

### Results

The average percentage reduction in fresh human milk volume after passive osmotic concentration using the Pouch was 16.3%±3.8%. Ten of the 41 analyzed hman milk components did not differ significantly (p>0.05) between unconcentrated and concentrated human milk: PAF acetylhydrolase activity, lysozyme activity, glutathione peroxidase activity, catalase activity, phosphocholine contracption, and the concentrations of the HMOs: LSTc, DFLNT, 6′SL, LNFPII, and 3FL.

Among the five enzymes assayed, only the increase in BSSL activity was significant at 21.5±39%; p<0.05). The increase in BSSL activity was also within the range. The concentrations of all nutrients analyzed by MIRIS, i.e., carbohydrates, crude protein, energy, total fat, true protein, and total solids, increased significantly (p<0.05) after treatment of human milk with the pouch. All increases were within the expected range. The concentrations of sodium, protein, lactose, lactoferrin, and active IgA also increased significantly (p<0.5) after passive osmotic concentration. All increases were within the expected range with the expectation of the increase in the concentration of active IgA (5.9+10.2%), which was smaller than expected. The concentrations of total fatty acids and all small molecules except phosphocholine increased significantly (p<0.05) after passive osmotic concentration. The increases in total fatty acids and SPH were within the expected range. The increases in betatine and free choline were greater than expected (32.4%±22.3% and 28.3%±9.6%, respectively.)

The concentrations of 14 of the 19 analyzed HMOs increased significantly (p<0.05) after passive osmotic concentration. The exceptions were LSTc, DFLNT, 6′SL, LNFP II and 3FL. 3FL was the single HMO to decrease in concentration though this was not significant. Among the other 14 HMOs, the increases in the concentrations of LSTb, LNH, LNnT, FLNH, LNFP I, FDSLNH, 3′SL, LNT, and 2′FL were within the expected range. The concentrations of LNFP III, DFLNH, DSLNH, and DSLNT increased more than expected, whereas the concentration of DFLac increased less than expected.

The mean pH of concentrated human milk (7.08±0.27) was lower than that of unconcentrated human milk (7.37±0.28), but this difference was not significant (p>0.05). The mean osmolality increased significantly (p<0.05) by 33%, from 295±3.44 mOsm in unconcentrated human milk to 392±28.7 mOsm in concentrated human milk.

The mean percentage of live cells did not differ significantly between unconcentrated human milk and concentrated human milk (7.63% versus 4.68%, p>0.05).

Throughout this disclosure, various publications, patents, or published patent. It could be, for example but not limited to, in the shape of a teabag. Once the forward osmotic membrane specifications may be referenced. The disclosures of these publications, patents, and published patent specifications are hereby incorporated by reference into the present disclosure to more fully describe materials and methods which may be used in conjunction with aspects of the described invention.

Certain embodiments of the devices, apparatuses, and methods disclosed herein are defined in the above examples. It should be understood that these examples, while indicating particular embodiments, are given by way of illustration only. From the above discussion and these examples, one skilled in the art can ascertain the essential characteristics of this disclosure, and without departing from the spirit and scope thereof, can make various changes and modifications to adapt the compositions and methods described herein to various usages and conditions. Various changes may be made and equivalents may be substituted for elements thereof without departing from the essential scope of the disclosure, and to adapt a particular situation or material to the teachings of the disclosure without departing from the essential scope thereof.

What is claimed is:

1. A method comprising:
placing, into contact with a quantity of un-concentrated, expressed human milk, a forward osmotic membrane separating a draw material exhibiting an osmotic draw property from the quantity of un-concentrated, expressed human milk to draw water from the quantity of un-concentrated, expressed human milk to form concentrated human milk; and
withdrawing the forward osmotic membrane from contact with the concentrated human milk.

2. The method of claim 1, further comprising:
measuring the quantity of un-concentrated, expressed human milk before placing the forward osmotic membrane.

3. The method of claim 1, comprising removing between 10% to 35% of water from the un-concentrated, expressed human milk to concentrate the expressed breast milk into concentrated breast milk.

4. The method of claim 1, wherein the draw material is a dry carbohydrate.

5. The method of claim 1, wherein the step of withdrawing the pouch is performed at a predetermined time following a time of placing the forward osmotic membrane.

6. The method of claim 1, further comprising:
placing the quantity of un-concentrated, expressed human milk into a container with measurement indicia; and wherein:
placing the forward osmotic membrane comprises placing the forward osmotic membrane at one end of the container such that the material is located within a second container opposite from the quantity of un-concentrated, expressed human milk in the direction of gravity; and
the step of withdrawing the pouch is performed when a level of the concentrated human milk indicated by the measurement indicia is a desired value.

7. The method of claim 1, further comprising: placing the quantity of un-concentrated, expressed human milk into a container with measurement indicia; and wherein:
placing the forward osmotic membrane comprises placing the forward osmotic membrane at one end of the container such that the material is located within a second container opposite from the quantity of un-concentrated, expressed human milk in the direction of gravity; and
the concentrated human milk reaches the desired nutrient level when no further water can be drawn into the second container.

8. The method of claim 1 wherein the forward osmotic membrane forms a pouch enclosing the draw material.

9. The method of claim 1 wherein the pouch is formed of two sheets of the forward osmotic membrane sealed about a common outer perimeter thereof or of a single sheet of the forward osmotic membrane sealed to itself to surround the material.

10. The method of claim 1 wherein the pouch is formed of a single sheet of the forward osmotic membrane sealed to an expandable sheet of material about a common outer perimeter thereof.

11. An apparatus, comprising:
a first sheet of material comprising a forward osmotic membrane;
a second sheet of material sealed to the first sheet of material about a common outer perimeter thereof, the first sheet of material arranged so that water can traverse the forward osmotic membrane to an interior of the first and second sheets; and
a dry carbohydrate within the interior of the first and second sheets exhibiting an osmotic draw property to draw water from un-concentrated, expressed human milk to form concentrated human milk.

12. A device for concentrating expressed breast milk, provided in a container, into concentrated breast milk, comprising:
a pouch, the pouch comprising:
at least one forward osmotic membrane defining an outer surface of the pouch; and
a draw material contained within an interior of the pouch; wherein
the draw material comprises a carbohydrate; and
the forward osmotic membrane is configured to contact the expressed breast milk in the container;
wherein the device removes water to concentrate the expressed breast milk into concentrated breast milk, whereby a total quantity of immunoglobulins is substantially the same in the concentrated breast milk as compared with the expressed breast milk.

13. The device of claim 12, wherein the at least one forward osmotic membrane is a first forward osmotic membrane, and is joined to a second forward osmotic membrane, wherein the first forward osmotic membrane and the second forward osmotic membrane are arranged back-to-back around the draw material, whereby the osmotic draw is to the interior of the pouch defined by the first forward osmotic membrane and the second forward osmotic membrane.

14. The device of claim 12, wherein the forward osmotic membrane has no nitrates.

15. The device of claim 12, wherein the pouch encloses between 10 g to 150 g dry weight of draw material and has a surface area in a range of: 20 cm² to 400 cm².

16. The device of claim 12, wherein the pouch comprises at lest one of: a drying agent, cellulose, glycerine, a polyester substrate, polyethylene substrate, high-density polyethylene (HDPE), low-density polyethylene (LDPE), medium-density polyethylene (MDPE), resin, ethylene polymer, or a thermoplastic resin.

17. The device of claim 12, wherein the device removes water to concentrate the expressed breast milk into concentrated breast milk, whereby the concentrated breast milk has between 1.1 to 2.0 times the Kcal per ounce, as compared with the expressed breast milk.

18. The device of claim 12, wherein the pouch is contained within a receptacle configured to removably attach to the container, the pouch is expandable, and wherein the receptacle is space-limited to prevent over-concentration.

19. The device of claim 12, wherein the pouch is single-use and disposable.
